(19) United States
(12) Patent Application Publication
(10) Pub. No.: US 2022/0053941 A1
(43) Pub. Date: Feb. 24, 2022

(54) BEDSTEAD

(71) Applicant: House & Home Co, Ltd., Xiamen (CN)

(72) Inventor: Xusheng Chen, Xiamen (CN)

(21) Appl. No.: 17/030,394

(22) Filed: Sep. 24, 2020

(30) Foreign Application Priority Data
Aug. 18, 2020 (CN) 202021721668.2

(51) Int. Cl. A47C 19/00; A47C 19/02; F16B 12/10

(52) U.S. Cl. CPC A47C 19/005; A47C 19/022; F16B 2012/106; A47C 19/027; F16B 12/10

(57) ABSTRACT

A bedstead includes a headboard, a footboard and two sideboards to form a bed frame. The two sideboards are connected with bed legs. A plurality of bed beams are mounted between the two sideboards. Each sideboard includes two connected side boards. The bed legs are connected to four corners of the bed frame. Aback of the headboard is formed with an accommodating cavity. After being disassembled, the side boards, the footboard, the bed beams and the bed legs are placed into the accommodating cavity. The bedstead can be assembled easily. It is more convenient to pack and transport the bedstead after being disassembled, thereby saving the transportation cost.

### BACKGROUND OF THE INVENTION

### 1. Field of the Invention

The present invention relates to a bed, and more particularly to a bedstead that is small in size after being disassembled.

### 2. Description of the Prior Art

A conventional bedstead generally includes a headboard, two sideboards, a footboard, a bed board support, and bed legs. When in use, one end of each sideboard is mounted to the headboard, and the other end of each sideboard is mounted to the footboard. The bed board support is mounted between the sideboards. The bed legs are connected to the two ends of each sideboard.

When the bed is to be transported, it is necessary to disassemble the headboard, the sideboards, the footboard, the bed legs, and the bed board support in turn, and then they are placed in a container. Because the parts are large and are scattered after being disassembled, they occupy a lot of space, which makes the transportation space larger. The number of beds to be transported in a shipping container is small, which increases the transportation cost. Especially for export companies, the transportation cost is too high.

When the bedstead is assembled, both ends of each sideboard need to be connected to the headboard and the footboard, respectively. It is required to set up multiple joints between the headboard and the sideboards for locking the headboard and the sideboards with screws and connecting plates. Then, the bed legs are connected to the sideboards as support legs. This greatly increases the complexity of the structure. There are many steps in installation and disassembly, which is more complicated.

### SUMMARY OF THE INVENTION

The primary object of the present invention is to provide a bedstead. The assembly of the bedstead is easier. It is more convenient to pack and transport the bedstead after being disassembled, thereby saving the transportation cost.

In order to achieve the above object, the present invention adopts the following solutions.

A bedstead comprises a headboard, a footboard and two sideboards to form a bed frame. The two sideboards are located between the headboard and the footboard. The two sideboards are connected with bed legs. A plurality of bed beams are mounted between the two sideboards. Each sideboard includes two connected side boards. A side tube is connected to an inner side of each side board. Either end of each bed beam is connected to the side tube. An upper section of each bed leg is defined as a connecting section. An outer end of each side board abuts against an inner side of the headboard or the footboard. The connecting section is formed with two perforation groups. Each perforation group includes at least one perforation formed on the connecting section for insertion of a screw. One of the perforation groups is aligned with a vertical line of the inner side of a corresponding one of the side boards. The other perforation group is aligned with a vertical line of the inner side of the headboard or the footboard. The inner side of the headboard, the inner side of the footboard and the inner side of each side board are formed with connecting holes corresponding in position to the perforations of the perforation groups, respectively. The screw is inserted through the perforation and locked to a corresponding one of the connecting holes so that the bed legs are connected to four corners of the bed frame. The outer ends of the side boards are connected to ends of the headboard and the footboard, respectively. A back of the headboard is formed with an accommodating cavity. After being disassembled, the side boards, the footboard, the bed beams and the bed legs are placed into the accommodating cavity.

Preferably, each perforation group of the connecting section includes at least two perforations transversely passing through the connecting section. The perforations of the two perforation groups are staggered in height and intersected horizontally.

Preferably, the connecting section of each bed leg is a square tube, a cylindrical tube, a square post, or a cylindrical post.

Preferably, the connecting section of each bed leg is a square tube or a cylindrical tube. Each perforation group of the connecting section includes at least two perforations transversely passing through the connecting section. Each perforation includes a pair of opposite perforations formed on a circumferential wall of the connecting section. The perforations of the two perforation groups are staggered in height

Preferably, a cover plate is pivotally connected to the headboard. The cover plate is configured to confine the side boards, the footboard, the bed beams and the bed legs to be stored in the accommodating cavity after the bedstead is disassembled.

Preferably, a middle portion of the bed frame is provided with a middle support. The middle support includes two middle support rods. Inner ends of the two middle support rods are connected. Outer ends of the two middle support rods are connected to middle portions of the inner sides of the headboard and the footboard, respectively. Each bed beam includes two bed beam rods. An outer end of each bed beam rod is mounted to the side tube, and an inner end of each bed beam rod is mounted to a corresponding one of the middle support rod.

Preferably, the side tube is provided with a plurality of side connectors. Each middle support rod is provided with a plurality of middle connectors. The outer end of each bed beam rod is movably inserted into a corresponding one of the side connectors, and the inner end of each bed beam rod is movably inserted into a corresponding one of the middle connectors.

Preferably, the side tube and each middle support rod are provided with multiple pairs of receiving holes, respectively. The side connectors and the middle connectors are insertedly connected to the pairs of receiving holes, respectively. The side connectors and the middle connectors each include a receiving block and a pair of pins beneath the receiving block to be insertedly connected to the pairs of receiving holes, respectively. The receiving block is formed with a slot into which either end of each bed beam rod is inserted.

Preferably, the middle portion of the bed frame is provided with a transverse support. Two ends of the transverse support are connected to middle portions of the two sideboards, respectively. The transverse support includes a transverse support rod and at least two support legs connected to an underside of the transverse support rod. The inner end of each middle support rod is mounted to a middle portion of the transverse support rod.

Preferably, the side tube is locked to the inner side of each side board by a plurality of screws. The two side boards of each sideboard are connected by a connecting rod.

After adopting the above structure, in the bedstead of the present invention, the bed legs are installed at the four corners of the bed frame. While the bed legs are installed, the sideboards can be connected with the headboard and the footboard, so that the structure is simpler, the installation steps are reduced, and the installation is easier. Besides, the bedstead can be placed in the headboard after being disassembled, so that the entire bed is small in size for transportation. A shipping container can accommodate more beds, thereby saving the transportation space and cost.

### BRIEF DESCRIPTION OF THE DRAWINGS

FIG. 1 is a perspective view of the present invention;

FIG. 2 is an exploded view of the present invention;

FIG. 3 is a schematic view of the present invention, illustrating that the side tube is to be connected to the side board;

FIG. 4 is a schematic view of the present invention, illustrating that the two side boards are to be connected together;

FIG. 5 is a schematic view of the present invention, illustrating that the bed legs are to be connected to the side boards;

FIG. 6 is a schematic view of the present invention, illustrating that the headboard, the footboard, the sideboards and the bed legs are assembled;

FIG. 6A is a schematic view illustrating that one bed leg in FIG. 6 is to be connected;

FIG. 7 is a schematic view of the transverse support of the present invention;

FIG. 8 is a schematic view of the present invention, illustrating that the transverse support is connected to the bed frame;

FIG. 8A is a schematic view illustrating that the transverse support in FIG. 8 is to be connected to the side boards;

FIG. 9 is a schematic view of FIG. 8 provided with the middle support;

FIG. 9A is a schematic view illustrating that the outer end of the middle support rod in FIG. 9 is to be connected to the headboard;

FIG. 9B is a schematic view illustrating that the inner end of the middle support rod in FIG. 9 is to be connected to the middle portion of the transverse support rod;

FIG. 10 is a schematic view of FIG. 9 provided with the bed beams;

FIG. 10A is a schematic view illustrating that the outer end of the bed beam rod in FIG. 10 is to be connected to the side connector of the side tube;

FIG. 10B is a schematic view illustrating that the inner end of the bed beam rod in FIG. 10 is to be connected to the middle connector;

FIG. 11 is a schematic view of the present invention after being disassembled, illustrating that the parts are placed into the accommodating cavity of the back of the headboard; and

FIG. 12 is a schematic view of the present invention after being disassembled and packed (the parts have been accommodated in the headboard).

### DETAILED DESCRIPTION OF THE PREFERRED EMBODIMENTS

Embodiments of the present invention will now be described, by way of example only, with reference to the accompanying drawings.

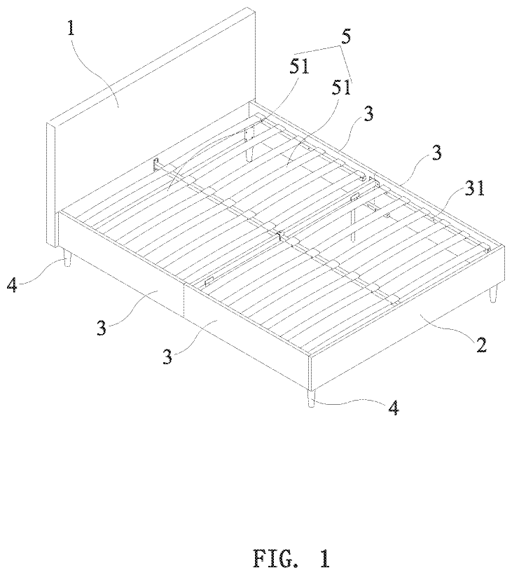

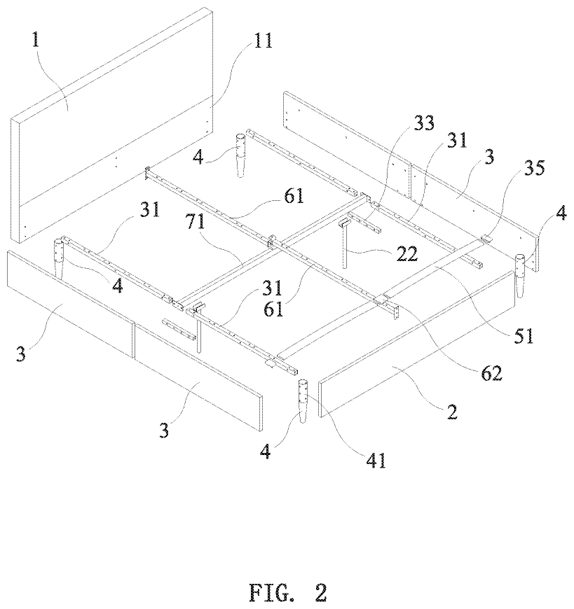

As shown in FIG. 1 and FIG. 2, the present invention discloses a bedstead. The bedstead comprises a headboard 1, a footboard 2 and two sideboards to form a bed frame. The two sideboards are located between the headboard 1 and the footboard 2. Each sideboard includes two connected side boards 3. The two sideboards are connected with bed legs 4. A plurality of bed beams 5 are mounted between the two sideboards. A side tube 31 is connected to the inner side of each side board 3. Either end of each bed beam 5 is connected to the side tube 31.

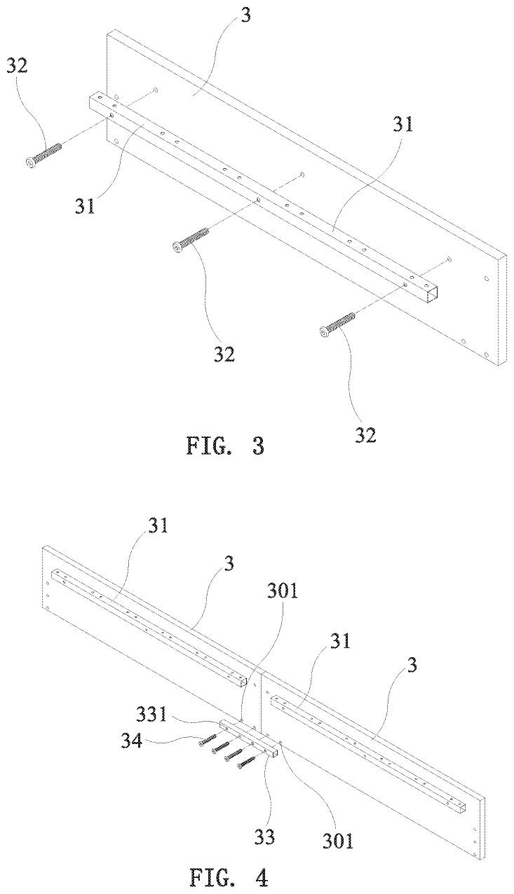

As shown in FIG. 3, the side tube 31 is locked to the inner side of the side board 3 by a plurality of screws 32. As shown in FIG. 4, the two side boards 3 of each sideboard are connected by a connecting rod 33. The inner ends of the two side boards 3 are formed with positioning holes 301, respectively. The connecting rod 33 is formed with positioning perforations 331. A plurality of screws 34 are inserted through the positioning perforations 331 and locked into the positioning holes 301 respectively, thereby connecting the two side boards 3.

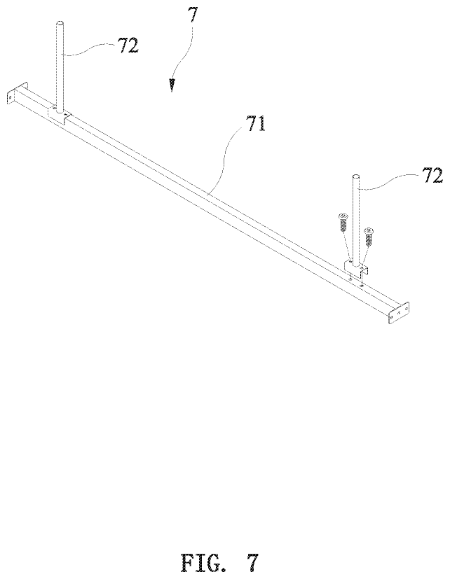

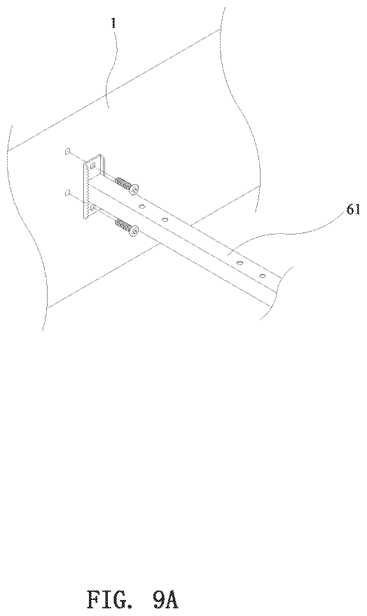

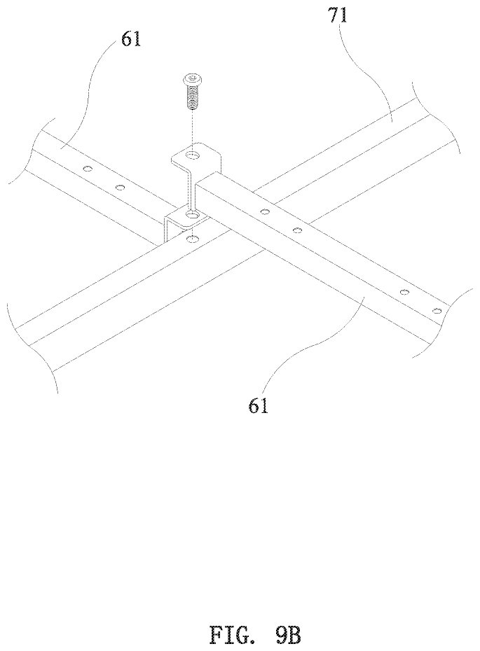

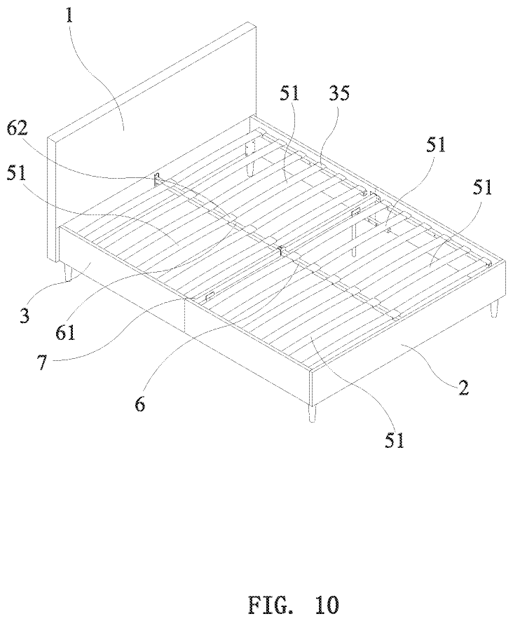

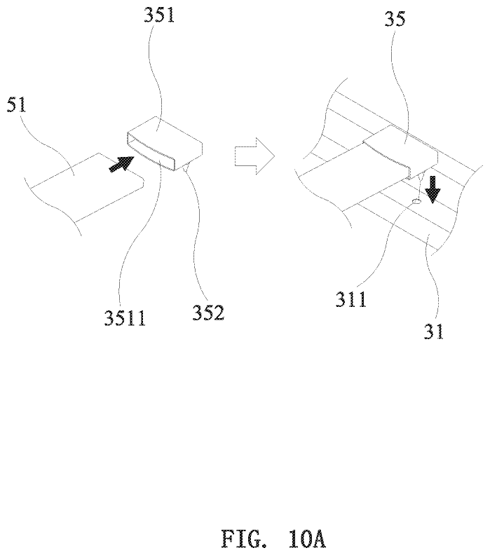

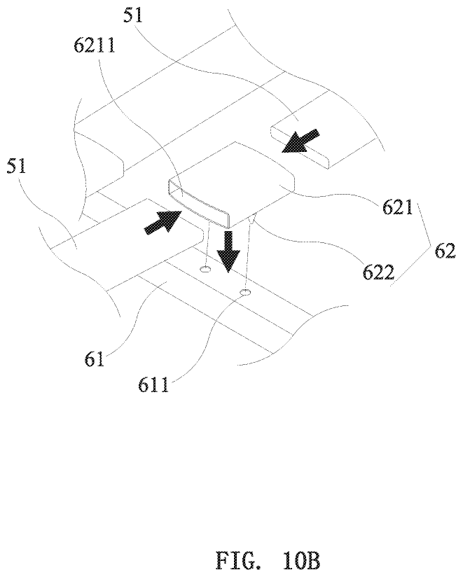

Further, in order to reduce the size of the bedstead after being disassembled, as shown in FIG. 1, FIG. 2, and FIG. 7 through FIG. 10, the middle portion of the bed frame is provided with a middle support 6. The middle support 6 includes two middle support rods 61. The inner ends of the two middle support rods 61 are connected. The outer ends of the two middle support rods 61 are connected to the middle portions of the inner sides of the headboard 1 and the footboard 2, respectively. As shown in FIG. 9A, the end of the middle support rod 61 is locked to the inner side of the headboard 1 by screws. As shown in FIG. 10, each bed beam 5 includes two bed beam rods 51. The outer end of each bed beam rod 51 is mounted to the side tube 31, and the inner end of each bed beam rod 51 is mounted to a corresponding one of the middle support rods 61. As shown in FIG. 10A and FIG. 10B, the side tube 31 is provided with a plurality of side connectors 35, and each middle support rod 61 is provided with a plurality of middle connectors 62. The outer end of each bed beam rod 51 is movably inserted into a corresponding one of the side connectors 35, and the inner end of each bed beam rod 51 is movably inserted into a corresponding one of the middle connectors 62. The side tube 31 and each middle support rod 61 are provided with multiple pairs of receiving holes 311, 611, respectively. The side connectors 35 and the middle connectors 62 are insertedly connected to the pairs of receiving holes, respectively. The side connectors 35 each includes a receiving block 351 and a pair of pins 352 beneath the receiving block 351 to be insertedly connected to the receiving holes 311, respectively. The receiving block 351 is formed with a slot 3511 into which the outer end of the bed beam rod 51 is inserted. The middle connectors 62 each include a receiving block 621 and a pair of pins 622 beneath the receiving block 621 to be insertedly connected to the positioning holes 611, respectively. The receiving block 621 is formed with a slot 6211 into which the inner end of the bed beam rod 51 is inserted. Both ends of the bed beam rod 51 can be smoothly inserted into the corresponding side connector 35 and the corresponding middle connector 62. The bed beam rods 51 are positioned in the bed frame to form a support for a mattress.

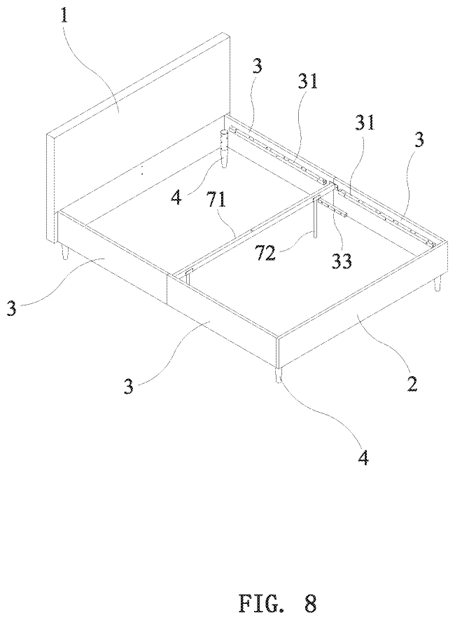

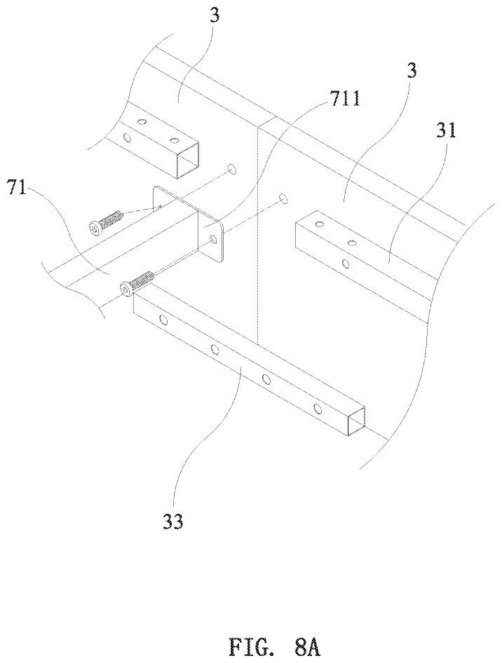

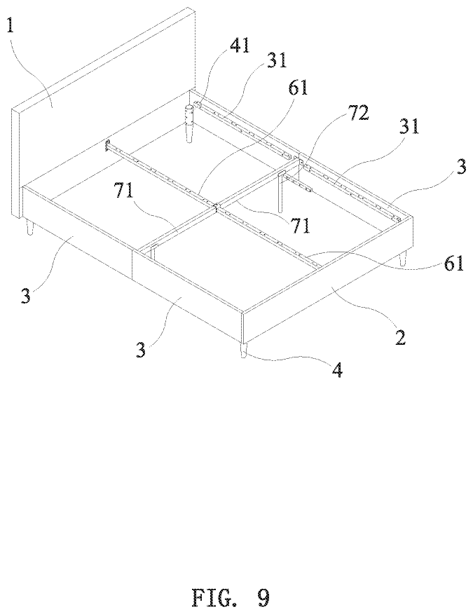

For the support and positioning of the middle support 6, support legs may be directly connected to the bottom of each middle support rod 61. In this embodiment, as shown in FIGS. 7-9, the middle portion of the bed frame is provided with a transverse support 7. Two ends of the transverse support 7 are connected to the middle portions of the two sideboards, respectively. As shown in FIG. 7, the transverse support 7 includes a transverse support rod 71 and at least two support legs 72 connected to the underside of the transverse support rod 71. As shown in FIG. 8A, either end of the transverse support rod 71 is locked to the two connected side boards 3 through a connecting plate 711. As shown in FIG. 9B, the inner end of each middle support rod 61 is mounted to the middle portion of the transverse support rod 71, so that the middle support rods 61 can be supported and mounted to the middle portion of the bed frame to support the bed beam rods 51.

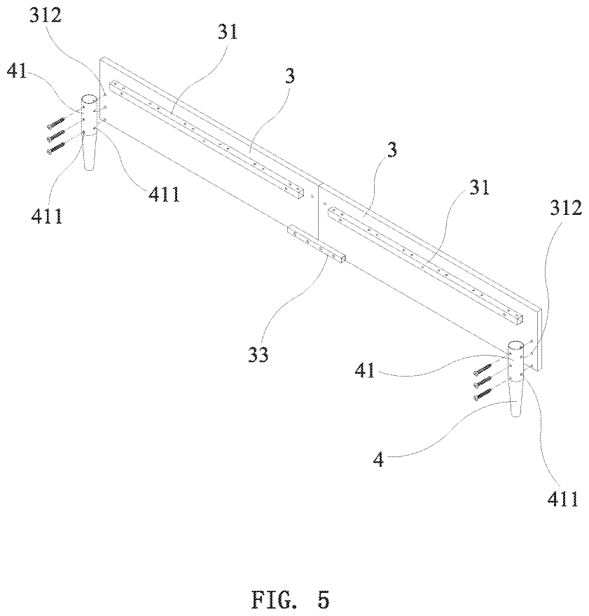

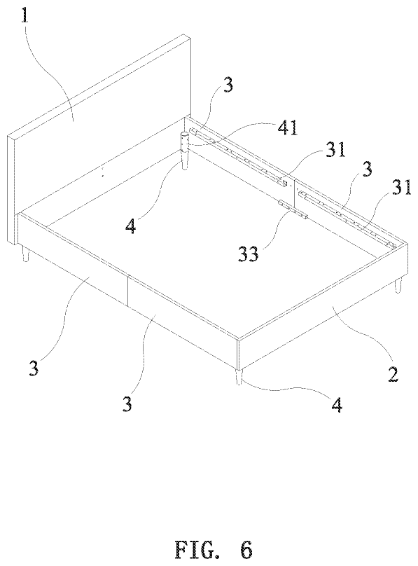

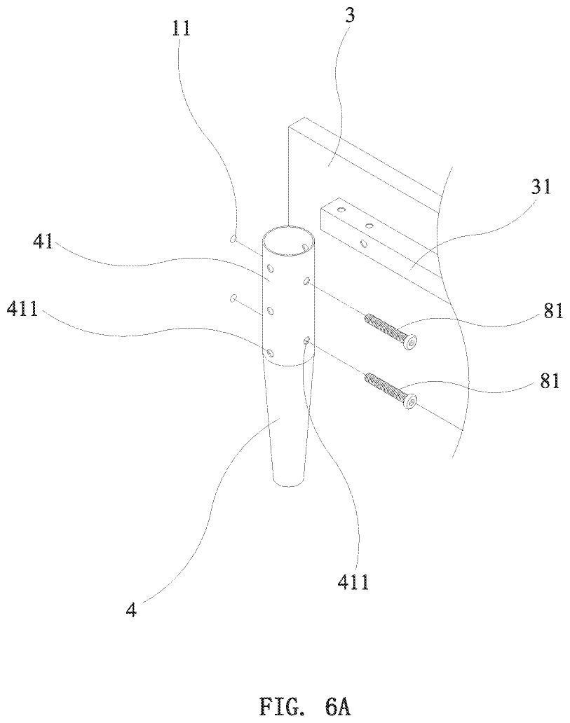

In the present invention, in order to simplify the installation of the bed legs 4 and make the connection between the side boards 3 and the headboard 1 as well as the footboard 2 easier, the bed legs 4 are located at the four corners of the bed frame, so that the bed legs 4 are connected to the side boards 3 and are also connected to the headboard 1 or the footboard 2. As shown in FIG. 1, FIG. 2, FIG. 5, and FIG. 6, an upper section of each bed leg 4 is defined as a connecting section 41. The outer end of each side board 3 abuts against the inner side of the headboard 1 or the footboard 2. The connecting section 41 is formed with two perforation groups. Each perforation group includes at least one perforation 411 formed on the connecting section 41 for insertion of a screw 81. One of the perforation groups is aligned with the vertical line of the inner side of the corresponding side board 3, and the other perforation group is aligned with the vertical line of the inner side of the headboard 1 or the footboard 2. The inner side of the headboard 1, the inner side of the footboard 2 and the inner side of each side board 3 are formed with connecting holes corresponding in position to the perforations 411, respectively. (The connecting holes 11 of the headboard 1 is shown in FIG. 6A, the connecting holes 312 of the side board 3 is shown in FIG. 5, and the connecting holes of the footboard 2 are not shown.) The screw 81 is inserted through each perforation group and locked to the corresponding connecting hole. As shown in FIG. 5 and FIG. 6A, the bed legs 4 are connected to the four corners of the bed frame, and the outer ends of the side boards 3 are connected to the ends of the headboard 1 and the footboard 2, respectively.

The connecting sections 41 of the bed legs 4 are attached to the four corners of the bed frame. The connecting section 41 may be a square tube, a cylindrical tube, a square post or a cylindrical post, etc. The bed legs 4 are located at the corners of the bed frame, respectively. At least two surfaces of the connecting section 41 are attached to the inner sides of the sideboard and the headboard or the footboard, respectively. Each perforation group of the connecting section 41 includes at least two perforations 411 transversely passing through the connecting section 41. As shown in FIG. 6A, in order to stagger the screws 81 locked to the headboard and the screws locked to the sideboard 3, without affecting the connection and locking, the perforations 411 of the two perforation groups are staggered in height and intersected horizontally. In this embodiment, the connecting section 41 of the bed leg is a cylindrical tube, and each perforation group of the connecting section 41 includes at least two perforations 411 transversely passing through the connecting section 41. Each perforation 411 includes a pair of opposite perforations formed on the circumferential wall of the connecting section 41, and the perforations of the two perforation groups are staggered in height. When the bedstead is assembled and installed, the side boards 3 are located between the headboard 1 and the footboard 2. Through the connecting section 41 of the bed leg 4, the side board 3 can be connected with the headboard 1 or the footboard 2, and the bed leg 4 can be directly installed. This makes the structure simpler and the operation easier.

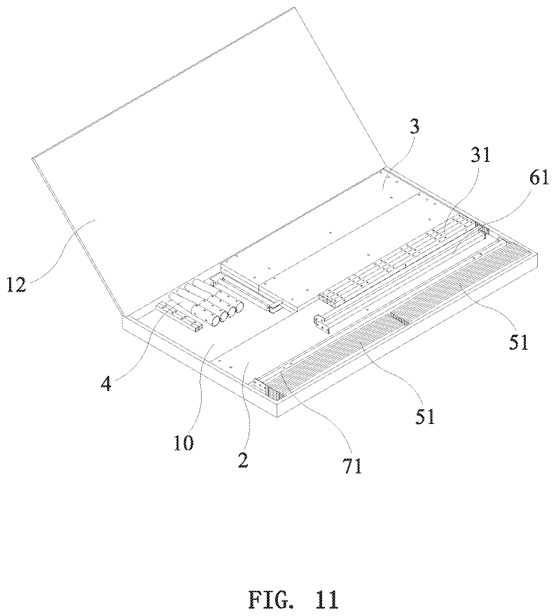

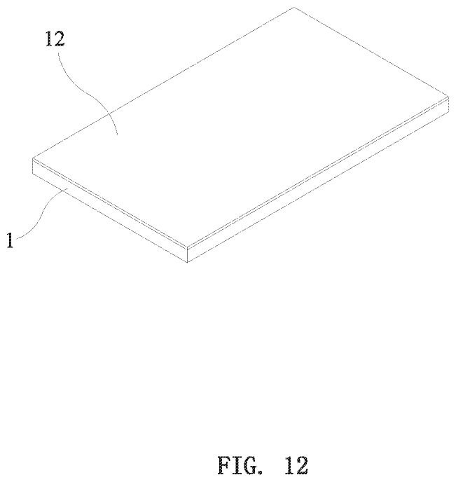

Further, in order to facilitate packaging and transportation of the bedstead after being disassembled, as shown in FIG. 11 and FIG. 12, an accommodating cavity 10 is formed on the back of the headboard 1. After the bedstead is disassembled, the side boards 3, the footboard 2, the bed beam rods 51 of the bed beams 51 after being disassembled, the bed legs 4, the middle support rods 61 of the middle support 6 after being disassembled, the transverse support rod 71 and the support legs 72 of the transverse support 7 after being disassembled are placed into the accommodating cavity 10. A cover plate 12 is pivotally connected to the headboard 1. The cover plate 12 is configured to confine the disassembled parts in the accommodating cavity 10, and then the cover plate 12 is fastened by fasteners (not shown in the figure), so as to achieve integrated packaging. After the bedstead is disassembled, the parts can be placed into the accommodating cavity 10 of the headboard 1 to prevent the parts from losing. The bedstead after being disassembled is small in size, which is beneficial for transportation, thereby saving transportation space and thus saving the transportation cost. Especially for export companies, this can save a lot of transportation cost.

As shown in FIGS. 3 to 10, when the bedstead of the present invention is assembled, the side tube 31 is first connected to the side board 3, and then the two side boards 3 are connected together to form the sideboard. The two sideboards are connected between the headboard 1 and the footboard 2. Through the connecting section 41 of the bed leg 4, the side board 3 can be connected with the headboard 1 or the footboard 2, and the bed leg 4 can be directly installed. The transverse support 7 is stalled between the two sideboards. The middle support 6 is connected between the headboard and the footboard. Finally, the bed beams 5 are installed as a bed support. The side connectors 35 and the middle connectors 62 are inserted and positioned onto the side tubes 31 and the middle support rods 61, respectively. The two ends of each bed beam rod 51 are insertedly connected to the side connector 35 and the middle connector 62, respectively. Each bed beam rod 51 is supported between the side tube 31 and the middle support rod 61, and has a certain support arc. After each bed beam rod 51 is installed, the entire assembly of the bedstead is completed. On the contrary, when the bedstead of the present invention is to be disassembled, the bed beam rods 51 are removed, the middle support 6 and the transverse support 7 are disassembled, the side boards 3 are separated, and the bed legs 4 are disassembled. After the disassembly is completed, all the parts are sequentially put into the accommodating cavity 10 of the headboard 1 for storage, such that the disassembled bedstead can be packaged in the headboard 1 as a whole.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. A bedstead, comprising a headboard, a footboard and two sideboards to form a bed frame, the two sideboards being located between the headboard and the footboard, the two sideboards being connected with bed legs, a plurality of bed beams being mounted between the two sideboards;
each sideboard including two connected side boards, a side tube being connected to an inner side of each side board, either end of each bed beam being connected to the side tube;
an upper section of each bed leg being defined as a connecting section, an outer end of each side board abutting against an inner side of the headboard or the footboard, the connecting section being formed with two perforation groups, each perforation group including at least one perforation formed on the connecting section for insertion of a screw, one of the perforation groups being aligned with a vertical line of the inner side of a corresponding one of the side boards, the other perforation group being aligned with a vertical line of the inner side of the headboard or the footboard, the inner side of the headboard, the inner side of the footboard and the inner side of each side board being formed with connecting holes corresponding in position to the perforations of the perforation groups respectively, the screw being inserted through the perforation and locked to a corresponding one of the connecting holes so that the bed legs are connected to four corners of the bed frame, the outer ends of the side boards being connected to ends of the headboard and the footboard, respectively;
a back of the headboard being formed with an accommodating cavity;
wherein after being disassembled, the side boards, the footboard, the bed beams and the bed legs are placed into the accommodating cavity.

2. The bedstead as claimed in claim 1, wherein each perforation group of the connecting section includes at least two perforations transversely passing through the connecting section, and the perforations of the two perforation groups are staggered in height and intersected horizontally.

3. The bedstead as claimed in claim 1, wherein the connecting section of each bed leg is a square tube, a cylindrical tube, a square post, or a cylindrical post.

4. The bedstead as claimed in claim 1, wherein the connecting section of each bed leg is a square tube or a cylindrical tube, each perforation group of the connecting section includes at least two perforations transversely passing through the connecting section, each perforation includes a pair of opposite perforations formed on a circumferential wall of the connecting section, and the perforations of the two perforation groups are staggered in height

5. The bedstead as claimed in claim 1, wherein a cover plate is pivotally connected to the headboard, and the cover plate is configured to confine the side boards, the footboard, the bed beams and the bed legs to be stored in the accommodating cavity after the bedstead is disassembled.

6. The bedstead as claimed in claim 1, wherein a middle portion of the bed frame is provided with a middle support, the middle support includes two middle support rods, inner ends of the two middle support rods are connected, outer ends of the two middle support rods are connected to middle portions of the inner sides of the headboard and the footboard respectively, each bed beam includes two bed beam rods, an outer end of each bed beam rod is mounted to the side tube, and an inner end of each bed beam rod is mounted to a corresponding one of the middle support rod.

7. The bedstead as claimed in claim 6, wherein the side tube is provided with a plurality of side connectors, each middle support rod is provided with a plurality of middle connectors, the outer end of each bed beam rod is movably inserted into a corresponding one of the side connectors, and the inner end of each bed beam rod is movably inserted into a corresponding one of the middle connectors.

8. The bedstead as claimed in claim 7, wherein the side tube and each middle support rod are provided with multiple pairs of receiving holes respectively, the side connectors and the middle connectors are insertedly connected to the pairs of receiving holes respectively, the side connectors and the middle connectors each include a receiving block and a pair of pins beneath the receiving block to be insertedly connected to the pairs of receiving holes respectively, and the receiving block is formed with a slot into which either end of each bed beam rod is inserted.

9. The bedstead as claimed in claim 6, wherein the middle portion of the bed frame is provided with a transverse support, two ends of the transverse support are connected to middle portions of the two sideboards respectively, the transverse support includes a transverse support rod and at least two support legs connected to an underside of the transverse support rod, and the inner end of each middle support rod is mounted to a middle portion of the transverse support rod.

10. The bedstead as claimed in claim 1, wherein the side tube is locked to the inner side of each side board by a plurality of screws, and the two side boards of each sideboard are connected by a connecting rod.
